(19) United States
(12) Patent Application Publication
(10) Pub. No.: US 2025/0091558 A1
(43) Pub. Date: Mar. 20, 2025

(54) Off-Road Vehicle

(71) Applicant: Zhejiang CFMOTO Power Co., Ltd., Hangzhou (CN)

(72) Inventors: Longping Luo, Hangzhou (CN); Liangchen Zhou, Hangzhou (CN); Zhicheng Wang, Hangzhou (CN); Wencai Fu, Hangzhou (CN); Zhaoyang Cheng, Hangzhou (CN)

(21) Appl. No.: 18/964,418

(22) Filed: Nov. 30, 2024

Related U.S. Application Data
(63) Continuation of application No. PCT/CN2023/096792, filed on May 30, 2023.

(30) Foreign Application Priority Data
May 30, 2022 (CN) 202210605865.5

(51) Int. Cl. B60T 13/12; B60K 17/34; B60R 25/04; B60R 25/24; B60R 25/33; B60T 1/06; B60T 7/04; B60T 7/08

(52) U.S. Cl. CPC B60T 13/12; B60K 17/34; B60R 25/04; B60R 25/245; B60R 25/33; B60T 1/065; B60T 7/04; B60T 7/08

(57) ABSTRACT

A brake system of an off-road vehicle includes a hand brake lever, a foot brake lever and a master cylinder. The hand brake lever can control both front and rear brake calipers by causing brake fluid to be input into an input chamber of the master cylinder, causing brake fluid pressure to increase in both primary and secondary chambers and brake fluid to flow out of both primary and secondary output ports. The foot brake lever can also control both the front and rear brake calipers via the master cylinder. A control system has an unlocking base station and a control module. The unlocking base station is capable of being wirelessly paired with a hand-carried transmitter. The control module will start the prime mover system only after assessment of a distance between the unlocking base station and the hand-carried transmitter based on a signal received from the hand-carried transmitter.

### RELATED APPLICATION INFORMATION

The present application is a continuation of and claims the benefits of priority to International Application Number PCT/CN2023/096792, entitled ALL-TERRAIN VEHICLE, filed on May 29, 2023, and further claims priority to Chinese Patent Application No. 202210605865.5, filed on May 30, 2022, entitled “Off-Road Vehicle”, and to Chinese Patent Application No. 202210941971.0, filed on Aug. 5, 2022, entitled “Off-Road Vehicle”, the entire disclosures of which are incorporated herein by reference.

### FIELD OF THE DISCLOSURE

The present application relates to the field of vehicles, in particular to an off-road vehicle.

### BACKGROUND OF THE DISCLOSURE

The term “off-road vehicles” refers to vehicles that can travel freely on terrains that are difficult for ordinary vehicles to travel. Off-road vehicles have a variety of uses and are not limited by road conditions. For use on such various terrains, off-road vehicles need high braking and structural performance.

In the existing off-road vehicles, a hand brake or a foot brake brakes a plurality of wheels of the off-road vehicle through a distribution valve. However, such existing brake systems often have many accessories, adding complexity both to assembly and operation and increasing cost.

### SUMMARY OF THE INVENTION

An off-road vehicles is provided to solve at least one of the technical problems above. To achieve the purpose, the present invention uses a technical solution as follows:

An off-road vehicle includes a frame, a plurality of wheels including a pair of front wheels and a pair rear wheels, a suspension system, a prime mover system and a brake system. The pair of front wheels are connected to the frame by a front suspension, and the pair of rear wheels are connected to the frame by a rear suspension. The prime mover system provides torque for the wheels to move the vehicle. The brake system is supported by the frame and used to brake the plurality of wheels. The brake system includes front brake calipers for braking the front wheels and rear brake calipers for braking the rear wheels. The brake system also includes a hand brake lever for controlling the set of brake calipers with brake fluid pressure generated by the hand brake lever and a foot brake lever for controlling the set of brake calipers.

In one aspect, a master cylinder for directing brake fluid is further included as part of the brake system. The master cylinder has a cylinder body defining an input chamber, a primary chamber with a primary output port and a secondary chamber with a secondary output port. The hand brake lever can control both the front brake calipers and the rear brake calipers by causing brake fluid to be input into the input chamber of the master cylinder, causing brake fluid pressure to increase in both the primary chamber and the secondary chamber and brake fluid to flow out of both the primary output port and the secondary output port to cause the front brake calipers to brake the pair of front wheels and to cause the rear brake calipers to brake the pair of rear wheels. the foot brake lever can control both the front brake calipers and the rear brake calipers, causing brake fluid pressure to increase in both the primary chamber and the secondary chamber and brake fluid to flow out of both the primary output port and the secondary output port to cause the front brake calipers to brake the pair of front wheels and to cause the rear brake calipers to brake the pair of rear wheels. The inventive master cylinder and brake circuit design decreases the number of accessories and simplifies the connection structure between the accessories of the brake system, thereby making the structure of the brake system more compact, facilitating the arrangement of the brake system, improving the space utilization of the off-road vehicle and reducing the cost of the brake system.

In another aspect, the off-road vehicle has a control system electrically communicating with the prime mover system. The control system has an unlocking base station and a control module. The unlocking base station includes a wireless communication module capable of being paired with a hand-carried transmitter. After the wireless communication module is successfully paired with the hand-carried transmitter, the unlocking base station is capable of receiving signals from the hand-carried transmitter by the wireless communication module. The control module will start the prime mover system only after assessment of a distance between the unlocking base station and the hand-carried transmitter based on a signal received from the hand-carried transmitter.

### BRIEF DESCRIPTION OF THE DRAWINGS

FIG. 1 is a rear left perspective view of an off-road vehicle of the present invention.

FIG. 2 is a schematic of a first embodiment of a brake system of the off-road vehicle of FIG. 1.

FIG. 3 is a schematic of a second embodiment of a brake system for use with the off-road vehicle of FIG. 1 in accordance with the present invention.

FIG. 4 is a cross-sectional view of the master cylinder of the brake system of FIG. 3.

FIG. 5 is a cross-sectional view of the master cylinder of the brake system of FIG. 3, modified to take a mechanical rather than hydraulic input from the foot brake pedal, but otherwise taken along break line 5-5 in FIG. 4.

FIG. 6 is a structure schematic of the off-road vehicle of FIG. 1 with a control system of the present invention.

FIG. 7 is a flowchart schematic of the control system process of the present

invention.

FIG. 8 is a structure schematic of the off-road vehicle of FIG. 1 using an alternative hand-carried transmitter and control system of the present invention.

FIG. 9 is a rear right exploded perspective view of a first preferred mounting position of the unlocking base station in the off-road vehicle of FIG. 1.

FIG. 10 is a front left exploded perspective view of a second preferred mounting position of the unlocking base station in the off-road vehicle of FIG. 1.

### DETAILED DESCRIPTION

For a better understanding of the purpose, technical solutions and advantages of the present invention, preferred embodiments of the present invention are described and illustrated below

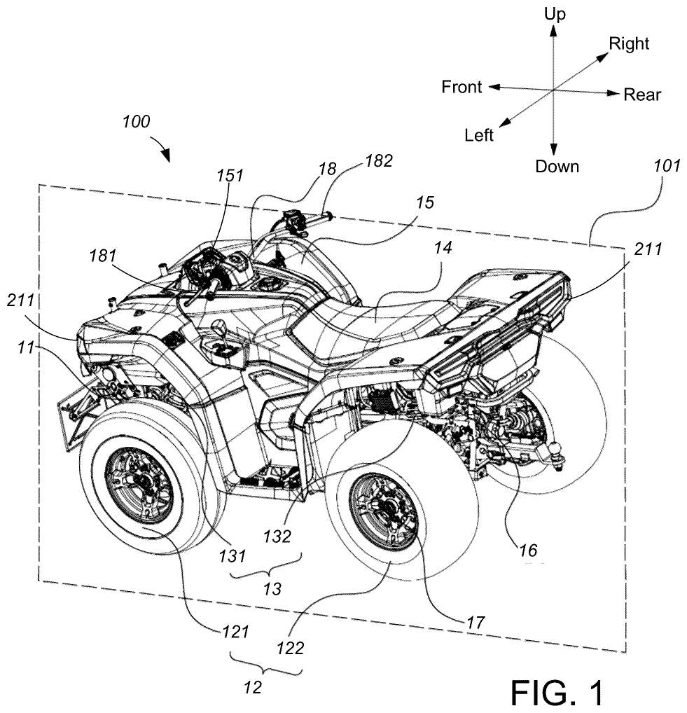

Referring to FIG. 1, an off-road vehicle 100 includes a frame 11, a plurality of wheels 12, a suspension system 13, a straddle-type saddle 14, a vehicle cover 15, a prime mover system 16, a brake system 17 and a steering assembly 18. The plurality of wheels 12 include front wheels 121 and rear wheels 122 used for movement of the off-road vehicle 100. The suspension system 13 is used to connect the frame 11 and the plurality of wheels 12, including a front suspension 131 for the front wheels 121 and a rear suspension 132 for the rear wheels 122. The saddle 14 is at least partially disposed on a top side of the frame 11 for riding by one or more users and/or passengers. The vehicle cover 15 is at least partially disposed on the frame 11. The prime mover system 16 is supported by the frame 11, and the prime mover system 16 is coupled to the plurality of wheels 12 and provides torque for the plurality of wheels 12, thereby providing locomotion for driving the vehicle 100. As called out in the schematic of FIG. 8, the prime mover system 16 can include an engine 161 for a fuel vehicle, a motor 162 for an electric vehicle, or both an engine 161 and a motor 162 for a hybrid vehicle. The brake system 17 is at least partially disposed on the frame 11 for braking the plurality of wheels 12, thereby braking the off-road vehicle 100. The steering assembly 18 is at least partially disposed on the frame 11 for controlling the running direction of off-road vehicle 100. The general orientations of front, rear, up (upper), down (lower), left and right for the ATV 100 are shown in FIG. 1 for clarity, as is a longitudinal midplane 101. The terms “up”, “down” “vertical”, “horizontal”, etc. used herein assume the vehicle wheels are on a flat, horizontal surface, i.e., not on a slope, and with the wheel/tire sizes depicted.

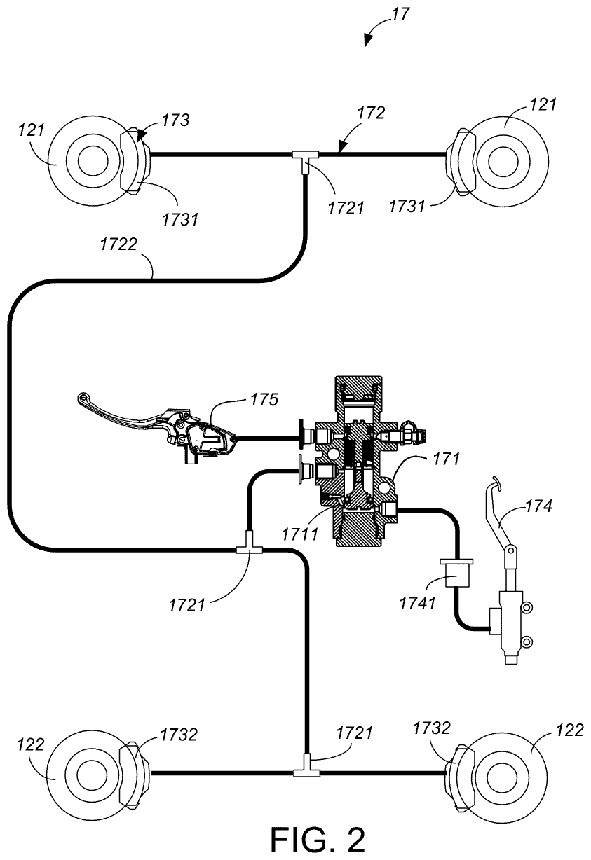

If desired, the brake system 17 can be as taught in U.S. Pat. Nos. 10,814,847 and 11,752,992, both incorporated by reference. More preferably, a first embodiment of the brake system 17 uses a hydraulic control valve 171 as taught in U.S. Pat. Nos. 10,814,847 and 11,752,992, but in a different brake circuit 172 as shown in FIG. 2. Specifically, all four brake calipers 173 are branched off of the output of the control valve 171 using Ts 1721 in the brake output lines 1722, rather than just the front brake calipers as taught in U.S. Pat. Nos. 10,814,847 and 11,752,992. If desired, the Ts 1721 can include check valves (not separately shown) which won't allow flow unless at least some back pressure is present, to separate the hydraulic brake line 1722 of one brake caliper 173 from the hydraulic brake lines 1722 of the other brake calipers 173 in case any of the brake lines 1722 fail. Proper positioning of the Ts 1721 in the brake circuit 172 can shorten the total length of hydraulic brake lines 1722 on the vehicle 100 and simplify the brake circuit 172.

Additionally, unlike the brake circuit taught in U.S. Pat. Nos. 10,814,847 and 11,752,992, the foot brake lever 174 does not have a direct connection to either the front brake calipers 1731 or the rear brake calipers 1732, but only causes braking of all four of the brake calipers 173 through the control valve 171. Thus, the brake circuit 172 as shown in FIG. 2 ensures that all four wheels 12 are braked equally.

Finally, the position of the hand brake lever 175 and the foot brake lever 174 and its reservoir 1741 are reversed relative to their positions connecting in to the control valve of the brake circuit taught in U.S. Pat. Nos. 10,814,847 and 11,752,992, which influences which brake lever 174, 175 can cause closing of the bypass channel 1711 (which brake lever 174, 175 closes the bypass channel 1711 takes on less significance when all four wheels 12 are braked equally). Should the brake line 1722 between the hand brake lever 175 and the control valve 171 fail, the foot brake lever 174 can still brake all four brake calipers 173. Similarly, should the brake line 1722 between the foot brake lever 174 and the control valve 171 fail, the hand brake lever 175 can still brake all four brake calipers 173, thereby improving the driving safety of the off-road vehicle 100.

The hand brake lever 175 is disposed on the left of the off-road vehicle 100, on the left grip portion 181. A throttle control (not separately shown) is usually disposed on the right grip portion 182 of the off-road vehicle 100. By arranging the hand brake lever 175 on the left of the off-road vehicle 100 and away from the throttle control, the safety of the driver when driving can be improved.

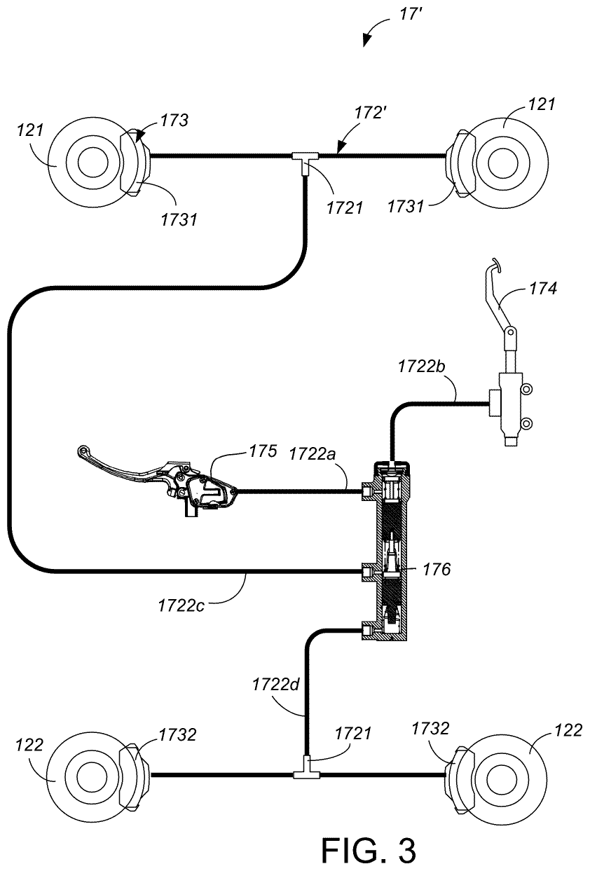

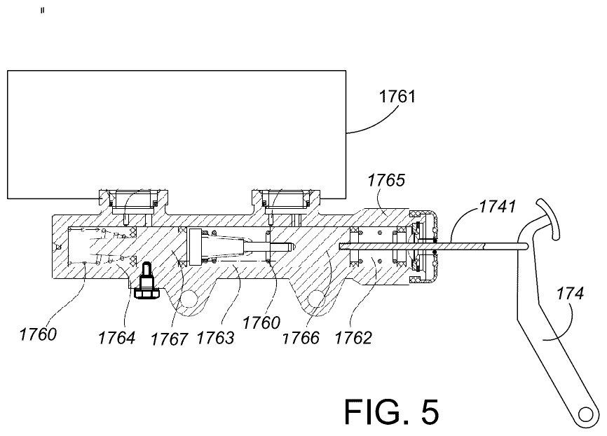

FIGS. 3-5 show a second set of alternatives for the braking system of the off-road vehicle 100. The brake system 17′ includes a dual master cylinder 176 instead of the control valve 171 of U.S. Pat. Nos. 10,814,847 and 11,752,992, and further omits the foot brake reservoir 1741 in favor of a common brake fluid reservoir 1761 (shown in FIG. 5). The dual master cylinder 176 includes chambers 1762, 1763, 1764 filled with brake fluid and replaces the function of the foot brake reservoir 174, thereby decreasing the number of accessories of the brake system 17′ and simplifying the brake circuit 172′. The master cylinder 176 is simpler and smaller than the control valve 171 of U.S. Pat. Nos. 10,814,847 and 11,752,992. The brake system 17′ is more compact, facilitating arrangement of the brake system 17′ and space utilization of the off-road vehicle 100, and reducing the cost of the brake system 17′.

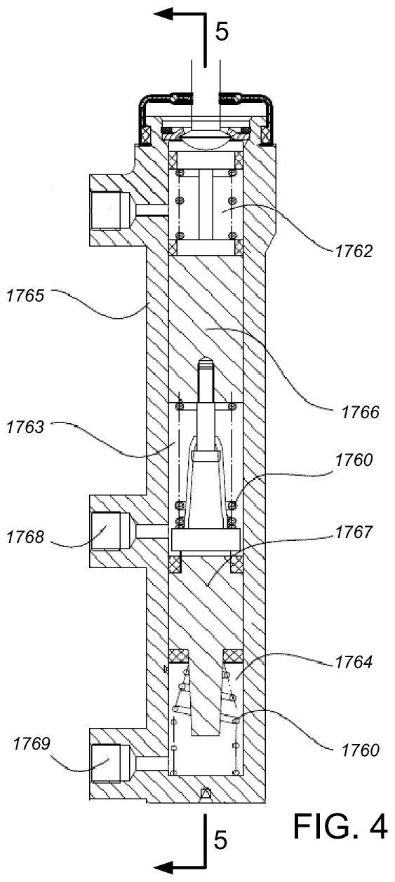

As called out in FIGS. 4 and 5, the master cylinder 176 includes a cylinder body 1765, with a primary piston 1766 and a secondary piston 1767 each of which are separately movable within the cylinder body 1765 by sliding motion along an axis of the cylinder body. An input chamber 1762 on one side (top side as depicted in FIGS. 3 and 4, but note that the orientation of the master cylinder in sheets 3 and 4 does not need to be the same as the up and down directions of FIG. 1) of the primary piston 1766 is hydraulically connected to both the hand brake lever 175 and the foot brake lever 174 through hydraulic lines 1722a, 1722b. A primary output chamber 1763 of the master cylinder 176, located between the primary piston 1766 and the secondary piston 1767, is hydraulically connected to the front brake calipers 1731 through a primary output port 1768 and front brake lines 1722c. A secondary output chamber 1764 of the master cylinder 176, located on the other side (bottom side as depicted in FIGS. 3 and 4) of the secondary piston 1767, is hydraulically connected to the rear brake calipers 1732 through a secondary output port 1769 and rear brake lines 1722d. Movement of the secondary piston 1767, in the downward direction as depicted in FIGS. 3 and 4, pushes brake fluid to the rear brake calipers 1732 to brake the rear wheels 122. Movement of the primary piston 1766 closer to the secondary piston 1767 pushes brake fluid to the front brake calipers 1731 to brake the front wheels 121. Reset members 1760 such as compression springs bias both the secondary piston 1767 and the primary piston 1766 toward a non-braking position, i.e., in the upward direction as depicted in FIGS. 3 and 4. As long as the primary piston 1766 and the secondary piston 1767 are both in the non-braking position, the primary chamber 1763 and the secondary chamber 1764 are both supplied with brake fluid from the reservoir 1761 shown in FIG. 5. As soon as the primary piston 1766 and the secondary piston 1767 move downwardly and begin braking, hydraulic connection with the reservoir 1761 is cut off, so brake fluid is not pushed from the chambers 1763, 1764 into the reservoir. The reservoir 1761 may be an oil cup or the like. The hand brake lever 175 and the foot brake lever 174 both act through the master cylinder 176, pushing the primary piston 1766 and the secondary piston 1767 against the reset members 1760 to individually or jointly control the brake calipers 173 to brake the plurality of wheels 12. In other words, the driver can use the hand brake lever 175 alone to brake all four wheels 12, can use the foot brake lever 174 alone to brake all four wheels 12, or can use both the hand brake lever 175 and the foot brake lever 174 to brake all four wheels 12. Moreover, any safety hazard due to the failure of one of the hand brake lever 175 or the foot brake lever 174 is avoided.

The hydraulic brake pipelines 1722 are separated into four individual portions 1722a, 1722b, 1722c, 1722d. If one portion a-d of the brake pipelines 1722 fails, the remainder of the circuit 172′ can still operate, thereby improving the driving safety of the off-road vehicle 100.

In one preferred embodiment shown in FIG. 5, the foot brake lever 174 mechanically moves a push rod 1742 which is directly attached to the primary piston 1766. In particular, the push rod 1742 extends through a wall in the cylinder body 1765 and extends through the input chamber 1762. In such an embodiment, pushing/movement the hand brake lever 175 will move the primary piston 1766, which in turn will always cause movement of the foot brake lever 174. With the foot brake lever 174 mechanically moving the primary piston 1766, failure of the hydraulic line 1722a between the hand brake lever 175 and the input chamber 1762 does not result in total brake failure. In other embodiments as shown in FIGS. 3 and 4, the foot brake lever 174 is hydraulically connected into the brake fluid input chamber 1762.

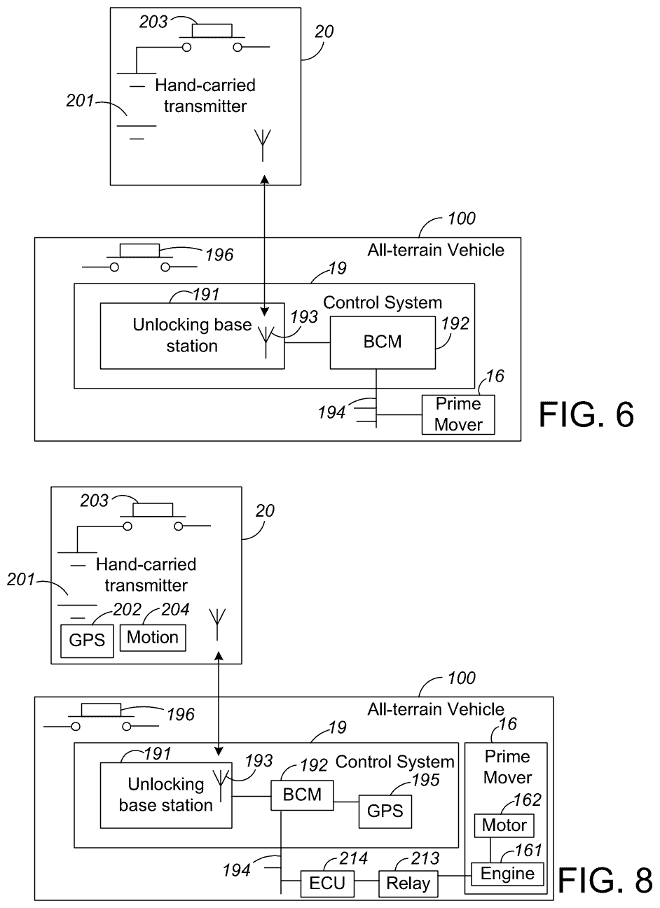

The off-road vehicle 100 further includes a control system 19, a portion of which is schematically shown in FIG. 6. The control system 19 includes unlocking base station 191 which can be mounted at any convenient, protected location on the vehicle 100. Preferred types of unlocking base stations 191 are a Key Base Station (KBS) or a Telematics BOX (T-BOX). The unlocking base station 191 is electrically connected to a first controller 192 which is preferably a body control module or “BCM”, such as through a direct wired connection or more preferably by having both components 191, 192 on a vehicle controller area network (CAN-bus) 194. The unlocking base station 191 provides anti-theft authentication for the BCM 192, and the vehicle 100 can only be powered on and/or the prime mover system 16 can only be started after successful anti-theft authentication.

The unlocking base station 191 includes a wireless communication module 193 that can be paired with a hand-carried transmitter 20 for unlocking the off-road vehicle 100. The hand-carried transmitter 20 is a movable device which can be carried by hand, i.e., the hand-carried transmitter 20 can be a mobile terminal with wireless capabilities such as a smartphone, etc., but more preferably is a key fob. The hand-carried transmitter 20 is preferably powered by battery 201. In the preferred embodiment, the hand-carried transmitter 20 can communicate with the wireless module 193 using a short-range radio frequency adaptive frequency hopping protocol such as BLUETOOTH, preferably BLUETOOTH 5.2. After the wireless module 193 is paired with the hand-carried transmitter 20 successfully, the unlocking base station 191 is capable of transceiving signals with the hand-carried transmitter 20 via the wireless module 193. The anti-theft authentication involves the hand-carried transmitter 20 sending an encrypted code to the unlocking base station 191, and the unlocking base station 191 receiving the encrypted code through its wireless module 193 and verifying a match that the hand-carried transmitter 20 corresponds in a one-to-one relationship with the vehicle 100; i.e., the vehicle 100 can only be powered on and/or the prime mover system 16 can only be started with the correct (factory and/or dealer assigned) hand-carried transmitter 20, and the hand-carried transmitter 20 can only start the correct (factory and/or dealer assigned) vehicle 100. If a match of the encrypted code is not achieved such as within 50 ms of pairing, the unlocking base station 191 unpairs with the hand-carried transmitter 20.

If desired, anti-theft authentication can be permitted whenever the hand-carried transmitter 20 is within wireless range and paired with the unlocking base station 191. More preferably, a different location based threshold is established between the hand-carried transmitter 20 and the unlocking base station 191 when anti-theft authentication is permitted. In one embodiment, the hand-carried transmitter 20 has a GPS chip 202 and the vehicle 100 also has a GPS chip 195, and GPS location information of the hand-carried transmitter 20 is transmitted to the wireless module 193. The unlocking base station 191 determines the distance between the GPS location information of the hand-carried transmitter 20 and the GPS location information of the vehicle 100, comparing that distance against a “close-enough” threshold value to decide whether to unlock the vehicle 100. For instance, if the unlocking base station 191 determines by GPS information that the hand-carried transmitter 20 is within 100 meters from the vehicle 100, then the unlocking base station 191 will unlock the vehicle 100. In another embodiment, only the hand-carried transmitter 20 has a GPS chip 202. Whenever the prime mover system 16 of the vehicle 100 is turned off, GPS information of the hand-carried transmitter 20 is sent to the unlocking base station 191 and stored. The next time the user tries to unlock the vehicle 100, the current GPS location information of the hand-carried transmitter 20 is sent to the unlocking base station 191. The unlocking base station 191 determines the distance between the current location information of the hand-carried transmitter 20 and the stored last-shut off GPS information, comparing that distance against a “close-enough” threshold value to decide whether to unlock the vehicle 100. In embodiments where distance is determined based on GPS information, the distance assessment is only as accurate as the GPS information. In the most preferred embodiment, before leaving the factory, the unlocking base station 191 of the vehicle 100 is calibrated with a pre-set transmission signal strength threshold value, such as a received signal strength indicator (RSSI) value, and when the signal strength of the hand-carried transmitter 20 is detected by the wireless module 193 to be greater than the pre-set transmission signal strength threshold value, then anti-theft authentication is permitted. In embodiments where the distance between the hand-carried transmitter 20 and the unlocking base station 191 is estimated solely by RSSI analysis, note that obstructions or objects between the between the hand-carried transmitter 20 and the unlocking base station 191, interference, weather conditions etc. may influence the RSSI value and the analysis may be somewhat inaccurate of the true distance.

In some embodiments, the threshold value to determine whether anti-theft authentication is permitted is fixed by the manufacturer. In other embodiments, the user can adjust the threshold value, selecting for his or herself the distance/signal strength when the hand-carried transmitter 20 is decided to be close enough to the unlocking base station 191 to permit unlocking of the vehicle/anti-theft authentication.

Pairing between the hand-carried transmitter 20 and the unlocking base station 191 can be carried out as known in the wireless communication art. Particularly when the wireless module 193 communicates using BLUETOOTH, pairing can be accomplished as known in BLUETOOTH communications. This can include any of a) having the unpaired hand-carried transmitter 20 continuously seeking the unlocking base station 191, and pairing whenever the hand-carried transmitter 20 is within wireless range of the unlocking base station 191; b) immediately (such as during the following 30 seconds) after a pairing/discovery button 203 on the hand-carried transmitter 20 is pressed by the user, having the unpaired hand-carried transmitter 20 seek the unlocking base station 191, pairing if the hand-carried transmitter 20 is within wireless range of the unlocking base station 191; and c) immediately (such as during the following 30 seconds) after a pairing/discovery button 203 on the hand-carried transmitter 20 is pressed by the user, having the unpaired hand-carried transmitter 20 seek the unlocking base station 191, and, if the hand-carried transmitter 20 is within wireless range of and discovers the unlocking base station 191, requiring a subsequent user confirmation command entry, such as pressing a button (not shown) on the vehicle 100, selecting the discovered vehicle 100 from a listed displayed on a display screen (not shown) of the hand-carried transmitter 20, or more preferably re-pressing the pairing/discovery button 203 on the hand-carried transmitter 20. The downside with embodiment a) of having the unpaired hand-carried transmitter 20 continuously seeking the unlocking base station 191 is that it consumes more battery power than the other two options b) and c). The downside of embodiment b), and moreso with embodiment c), is that pairing is more cumbersome for the user.

Once pairing is successfully completed, either the vehicle 100 or the hand-carried transmitter 20 can provide a signal to the user that pairing has been accomplished. For instance, the off-road vehicle 100 may include a visual interaction module and/or an audio interaction module which provides a signal that pairing has been accomplished. In the preferred embodiment, when pairing is accomplished the BCM 192 blinks the lights 211 of the off-road vehicle 100 and briefly sounds horn (not separately shown) of the off-road vehicle 100.

Once pairing has been achieved and the vehicle 100 has been unlocked (passed anti-theft authentication as discussed above), the vehicle 100 is placed in a “welcome” state. If desired, the BCM 192 can control the vehicle 100 to provide a signal to the user that the welcome state has been entered. In the preferred embodiment, the welcome-state-entry signal is separate from and in addition to any pairing-successful signal. In the most preferred embodiment, this involves having the BCM 192 blink the lights 211 and briefly sound the horn for a second time.

After being unlocked, the prime mover system 16 of the vehicle 100 is preferably started by a separate start command. In some embodiments, the separate start command is pressing a start button 196 on the vehicle 100 and/or inserting and turning a physical key (not shown, but which can be attached and integral with the hand-carried transmitter 20) into an ignition switch (not shown) of the vehicle 100. In other embodiments, the separate start command is a separate pressing of the button 203 on the hand-carried transmitter 20. When the vehicle 100 has been unlocked and the separate start command is performed by the user, the BCM 192 can start the prime mover system 16. In some embodiments, starting of the prime mover system 16 will only be executed if the unlocking base station 191 has performed a second comparison and determined from location information that the hand-carried transmitter 20 is closer than a second distance threshold to the hand-carried transmitter 20. For instance, in one embodiment, while the hand-carried transmitter 20 and the wireless module 192 have a maximum transmission distance of about 240 m, the vehicle 100 enters the welcome state (flashing its lights 211 and briefly sounding its horn) only if the button 203 on the hand-carried transmitter 20 is pressed while estimated based upon RSSI to be within 100 m of the unlocking base station 191, and can only be started thereafter by pressing of a start button 196 on the vehicle 100 or the button 203 on the hand-carried transmitter 20 only while estimated based upon RSSI to be within 10 m of the unlocking base station 191. If the start button 196 on the vehicle 100 is pressed prior to unlocking of the vehicle 100, the vehicle 100 will initiate and attempt to pair with the hand-carried transmitter 20, and will only proceed with starting of the prime mover system 16 after both a) pairing is completed; and b) the unlocking base station 191 has performed one or both proximity comparisons and authentication of the hand-carried transmitter 20 to unlock the vehicle 100.

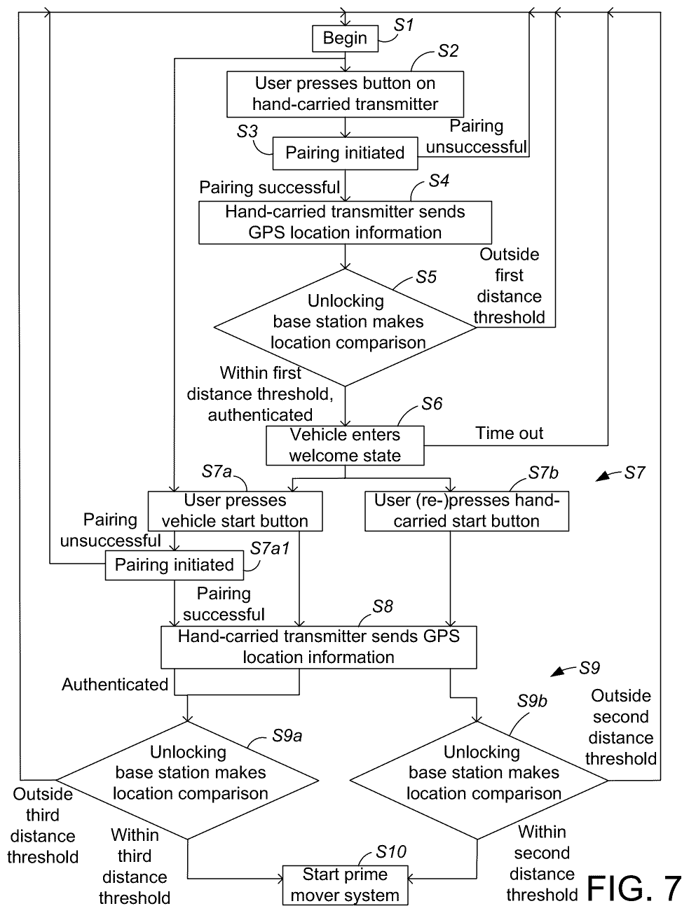

FIG. 7 shows the process for starting the preferred off-road vehicle 100 in flowchart form, as follows:
Step S1: Begin;
Step S2: the user presses the button 203 on the hand-carried transmitter 20. Note that this step S2 may be omitted in embodiments where the unpaired hand-carried transmitter 20 is continually seeking to pair with the unlocking base station 191;
Step S3: the hand-carried transmitter 20 initiates pairing with the unlocking base station 191. If the hand-carried transmitter 20 is within range and pairing is successful, the unlocking base station 191 proceeds with encrypted authentication to ensure that the hand-carried transmitter 20 corresponds to the vehicle 100 (and vice versa). Assuming that the hand-carried transmitter 20 is paired, the unlocking base station 191 will proceed to step S4; if pairing is unsuccessful or authentication fails, return to begin step S1;
Step S4: the hand-carried transmitter 20 if equipped with a GPS module 202 sends out location information. Note that this step S4 may be omitted in embodiments where the unlocking base station 191 determines distance of the hand-carried transmitter 20 solely by RSSI.;
Step S5: the unlocking base station 191 makes a location comparison, either based on GPS or RSSI, that the hand-carried transmitter 20 is within a first distance threshold (for instance, within 100 m) of the unlocking base station 191. Note that the timing of authentication relative to the timing of sending location information and/or the timing of making a location comparison is not critical. If within the first distance threshold, the process proceeds to step S6; if the hand-carried transmitter 20 is outside the first distance threshold relative to the unlocking base station 191, return to begin step S1;
Step S6: the BCM 192 causes the vehicle 100 to enter the welcome state, blinking its lights 211 and/or briefly sounding its horn. The welcome state may also allow various electronic devices (such as the vehicle dashboard display 212, the headlights 211 or the radio (not shown)) to function, including under control of other switches or buttons on the vehicle 100;
Step S7: Before timing out of the welcome state, the user either S7a) presses the start button 196 on the vehicle 100, or S7b) presses a separate start button (not shown) or re-presses the button 203 on the hand-carried transmitter 20. If the welcome state times out (such as a delay of more than 5 minutes), return to begin step S1. Note that, in embodiments where the hand-carried transmitter 20 does not attempt to initiate pairing without having the user first press a button 203 (which embodiments conserve battery life of the hand-carried transmitter 20), there are times when the user may press the start button 196 on the vehicle 100 without first entering the welcome state, such as keeping the hand-carried transmitter 20 in his or her pocket while boarding the vehicle 100 and then pressing the vehicle's start button 196. In such cases, a step S7a1 of pairing between the hand-carried transmitter 20 and the unlocking base station 191 must be achieved and the hand-carried transmitter 20 must be authenticated prior to proceeding;
Step S8: the hand-carried transmitter 20 if equipped with a GPS module 202 sends out location information. Note that this step S8 may be omitted in embodiments where the unlocking base station 191 determines distance of the hand-carried transmitter 20 solely by RSSI;
Step S9: the unlocking base station 191 makes a location comparison (in many cases, for the second time), either based on GPS or RSSI, that the hand-carried transmitter 20 is sufficiently close to the unlocking base station 191. If location comparison step S9 was initiated by step S7b of the user's pressing of a button 203 on hand-carried transmitter 20, the then the comparison is step S9b to see if the hand-carried transmitter 20 is within a second distance threshold (for instance, 10 m) of the unlocking base station 191; if within the second distance threshold, proceed to step S10; if outside the second distance threshold, return to step S1. Step S9b allows the user to perform a remote (while not seated on the vehicle 100) start of the vehicle 100 using only the hand-carried transmitter 20. If location comparison step S9 was initiated by step S7a of the user pressing the start button 196 on the vehicle 100, then the comparison is step S9a to see if the hand-carried transmitter 20 is within a third distance threshold (for instance, 2 m, such as in the driver's pocket when riding the vehicle 100) of the unlocking base station 191; if successfully determined to be within the third distance threshold, proceed to step S10; if not, return to start step S1; and
Step S10: the BCM 192 starts the prime mover system 16. Depending upon the design of the vehicle 100, the starting of the prime mover system 16 can be achieved with further electronic devices such as one or more relays 213, one or more electronic control modules 214, etc. as shown in FIG. 8

The steps illustrated in the above-described process and in the flowchart of the accompanying drawings can be performed in a computer system such as a set of computer-executable instructions. Though a logical sequence is illustrated in the flowchart, the steps illustrated or described may be performed in a different order from that shown or described herein in some instances. Through performing steps S1-S10, the vehicle 100 can meet the needs of different users and realize diverse designs of the off-road vehicle 100. Through the above steps S1-S10, the hand-carried transmitter 20 can be authenticated with the unlocking base station 191. The inventive method and vehicle and hand-carried transmitter design improves the efficiency and anti-theft properties of the off-road vehicle 100.

In some embodiments, the unlocking base station 191 and the hand-carried transmitter 20 continue to communicate with each other at regular time intervals (such as once every 10 seconds) whenever the prime mover system 16 is running. The unlocking base station 191 verifies that the hand-carried transmitter 20 is sufficiently close (such as within the second or third distance threshold) at each such time interval. If the hand-carried transmitter 20 moves too far away from the vehicle 100, the unlocking base station 191 can cause the BCM 192 to turn the prime mover system 16 off. Such a system adds safety by not allowing the prime mover system 16 to run unattended if the driver should step away or be thrown from the vehicle 100.

In some embodiments, the hand-carried transmitter 20 also has a motion sensor 204 as shown in FIG. 8. When the motion sensor 204 determines that the hand-carried transmitter 20 is static, the hand-carried transmitter 20 maintains low power operation, which can reduce the energy consumption of the hand-carried transmitter 20 and increase the time between battery changes. When the hand-carried transmitter 20 moves, the hand-carried transmitter 20 attempts to pair with the unlocking base station 191. In embodiments in which the hand-carried transmitter 20 also has a motion sensor 204, pairing and authentication will be usually achieved while the driver approaches the vehicle 100 on foot.

The unlocking base station 191 is preferably disposed on the upper side of the frame 11, just underneath a portion of the vehicle cover 15 or in a body panel of the vehicle cover 15. In addition, the unlocking base station 191 is preferably disposed toward the front of the vehicle 100. By mounting the unlocking base station 191 toward the top and front of the vehicle 100, interference with communication signals caused by metal objects such as the frame 11 is minimized, thereby improving communication between the unlocking base station 191 and the hand-carried transmitter 20. Mounting the unlocking base station 191 toward the top and front of the vehicle 100 also increases the distance between the unlocking base station 191 and the prime mover assembly 16, minimizing heat effects of the engine 161 and/or the motor 162 and avoiding overheating of the unlocking base station 191. Preferred embodiments mount the unlocking base station 191 forward of the steering hand grips 181, 182 and mount the prime mover system 16 rearward of the steering hand grips 181, 182. Mounting the unlocking base station 191 below or within the vehicle cover 15 protects the unlocking base station 191 from precipitation and spray.

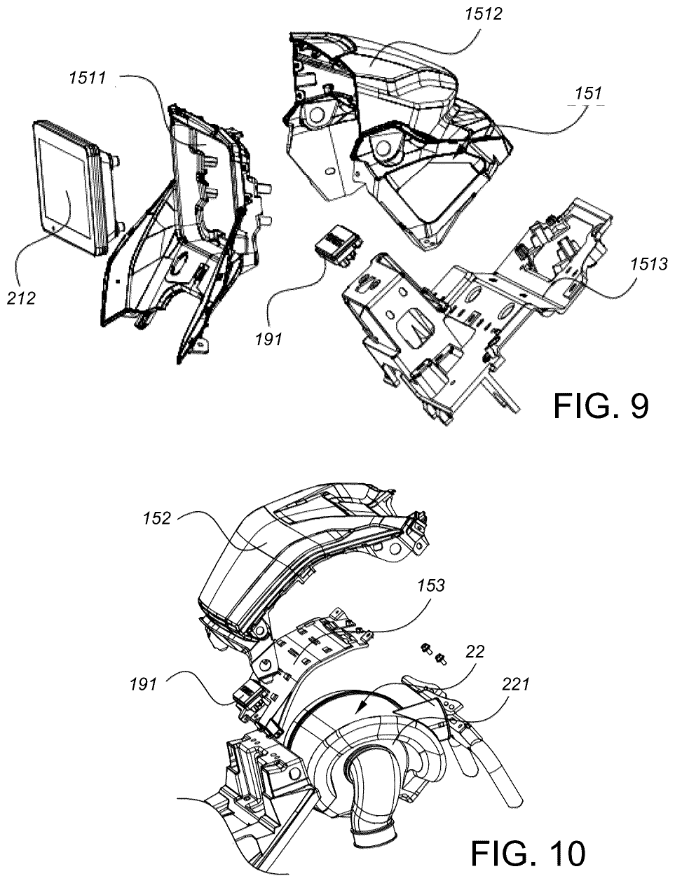

FIGS. 9 and 10 show two potential mounting locations for the unlocking base station 191 in more detail. In the embodiment of FIG. 9, the unlocking base station 191 is positioned in an instrument panel 151 of the vehicle cover 15, such as just beneath a graphical display panel 212 and above the frame 11. The instrument panel 151 is roughly bisected by the longitudinal midplane 101, toward the top of the off-road vehicle 100 and in a position to be viewed by the driver when driving the off-road vehicle 100. The display panel 212 is sandwiched between a rear panel 1511 and a mating front panel 1512. The rear and from panels 1511, 1512 are mounted from a base bracket 1513 which is used to fasten the instrument panel 151 to the frame 11. In this embodiment, the unlocking base station 191 is disposed beneath the display panel 212 on the base bracket 1513 of the instrument panel 151.

In the embodiment of FIG. 10, the unlocking base station 191 is positioned in an air intake system 22 of the off road vehicle 100. The air intake system 22 includes an air filter 221 disposed on the frame 11 and in the vehicle cover 15 in front of the instrument panel 151, roughly bisected by the longitudinal midplane 101. The vehicle cover 15 includes an air filter cover 152 disposed above the air filter 221 to obscure and cover the air filter 221. The unlocking base station 191 is disposed on an air filter mounting plate 153 just beneath the air filter cover 152 of the vehicle cover 15. Both the location of FIG. 9 and the location of FIG. 10 allow the unlocking base station 191 to meet the objectives discussed above of improving wireless communication reception, avoiding overheating and being protected from precipitation and spray.

It should be understood that the people skilled in the art can improve or transform according to the above description. and all such improvements and transformations shall fall within the scope of protection of the appended claims of the present application.

1. An off-road vehicle, comprising:
a frame;
a plurality of wheels, comprising at least a pair of front wheels and a pair of rear wheels;
a suspension system, with the plurality of wheels connected to the frame by the suspension system;
a prime mover system supported by the frame for providing torque to at least one of the pair of front wheels and the pair of rear wheels for locomotion of the off-road vehicle;
a brake system supported by the frame for braking the plurality of wheels; the brake system comprising:
a set of brake calipers for braking the plurality of wheels, the set of brake calipers comprising front brake calipers for braking the pair of front wheels and rear brake calipers for braking the pair of rear wheels;
a hand brake lever for controlling the set of brake calipers with brake fluid pressure generated by the hand brake lever;
a foot brake lever for controlling the set of brake calipers; and
a master cylinder for directing brake fluid, the master cylinder comprising a cylinder body defining an input chamber, a primary chamber with a primary output port and a secondary chamber with a secondary output port;
wherein the hand brake lever can control both the front brake calipers and the rear brake calipers by causing brake fluid to be input into the input chamber of the master cylinder, causing brake fluid pressure to increase in both the primary chamber and the secondary chamber and brake fluid to flow out of both the primary output port and the secondary output port to cause the front brake calipers to brake the pair of front wheels and to cause the rear brake calipers to brake the pair of rear wheels; and
wherein the foot brake lever can control both the front brake calipers and the rear brake calipers, causing brake fluid pressure to increase in both the primary chamber and the secondary chamber and brake fluid to flow out of both the primary output port and the secondary output port to cause the front brake calipers to brake the pair of front wheels and to cause the rear brake calipers to brake the pair of rear wheels.

2. The off-road vehicle of claim 1, wherein the primary output port is in brake fluid communication with only the front brake calipers and wherein the secondary output port is in brake fluid communication with only the rear brake calipers.

3. The off-road vehicle of claim 2, wherein the input chamber, the primary chamber and the secondary chamber are coaxially aligned, with the primary chamber located between the input chamber and the secondary chamber.

4. The off-road vehicle of claim 3, wherein the master cylinder further comprises a primary piston and a secondary piston, with the primary piston movably disposed between the input chamber and the primary chamber, with the secondary piston movably disposed between the primary chamber and the secondary chamber.

5. The off-road vehicle of claim 4, further comprising a secondary chamber compression spring disposed in the secondary chamber, with axial movement of the secondary piston to cause brake fluid flow out of the secondary output port also causing compression of the secondary chamber compression spring.

6. The off-road vehicle of claim 5, further comprising a primary chamber compression spring disposed in the primary chamber, with axial movement of the primary piston to cause brake fluid flow out of the primary output port also causing compression of the primary chamber compression spring.

7. The off-road vehicle of claim 1, wherein the master cylinder comprises a brake fluid reservoir, which when not braking supplies brake fluid to both the primary chamber and the secondary chamber.

8. The off-road vehicle of claim 1, wherein a push rod is disposed between the foot brake lever and the master cylinder, the foot brake lever controlling the master cylinder by means of the push rod.

9. The off-road vehicle of claim 1, wherein the off-road vehicle comprises a control system electrically communicating with the prime mover system; the control system comprising:
an unlocking base station comprising a wireless communication module capable of being paired with a hand-carried transmitter, wherein after the wireless communication module is successfully paired with the hand-carried transmitter, the unlocking base station is capable of receiving signals from the hand-carried transmitter by the wireless communication module; and
a control module electrically connected to the unlocking base station;
wherein the control module will start the prime mover system only after assessment of a distance between the unlocking base station and the hand-carried transmitter based on a signal received from the hand-carried transmitter.

10. The off-road vehicle of claim 9, wherein the distance between the unlocking base station and the hand-carried transmitter is assessed based on a received signal strength indicator of the signal received from the hand-carried transmitter.

11. The off-road vehicle of claim 9, wherein the signal received from the hand-carried transmitter comprises GPS position information of the hand-carried transmitter.

12. The off-road vehicle of claim 9, wherein the control module will start the prime mover system only after authenticating the hand-carried transmitter based on authentication information in the signal received from the hand-carried transmitter.

13. The off-road vehicle of claim 9, wherein, during running of the prime mover system, the control module assesses distance between the unlocking base station and the hand-carried transmitter, and wherein the control module can cause the prime mover system to stop if assessed distance between the unlocking base station and the hand-carried transmitter sufficiently increases.

14. The off-road vehicle of claim 9, wherein the off-road vehicle comprises a steering assembly with a right grip portion and a left grip portion, wherein the unlocking base station is mounted on the frame forward of the right grip portion and forward of the left grip portion.

15. The off-road vehicle of claim 9, wherein the off-road vehicle comprises a start switch, wherein the off-road vehicle can be started solely by user manipulation of the hand-carried transmitter while the hand-carried transmitter is within a first distance threshold from the unlocking base station, and wherein the off-road vehicle can be started solely by user manipulation of the start switch of the off-road vehicle while the while the hand-carried transmitter is within a second distance threshold from the unlocking base station, with the first distance threshold being longer than the second distance threshold.

16. The off-road vehicle of claim 9, wherein the prime mover system of the off-road vehicle can be started solely by user manipulation of the hand-carried transmitter, wherein the control module can place the off-road vehicle into a welcome state after assessing distance between the unlocking base station and the hand-carried transmitter to be less than a first distance threshold, wherein the hand-carried transmitter can only start the prime mover system of the off-road vehicle after assessing distance between the unlocking base station and the hand-carried transmitter to be less than a second distance threshold, with the first distance threshold being longer than the second distance threshold.

17. The off-road vehicle of claim 16, wherein the control module causes the off-road vehicle to signal when the welcome state is entered.

18. The off-road vehicle of claim 17, wherein the signal that the welcome state is entered comprises blinking of one or more lights on the off-road vehicle.

19. An off-road vehicle, comprising:
a frame;
a plurality of wheels, comprising at least a pair of front wheels and a pair of rear wheels;
a suspension system, with the plurality of wheels connected to the frame by the suspension system;
a prime mover system supported by the frame for providing torque to at least one of the pair of front wheels and the pair of rear wheels for locomotion of the off-road vehicle; and
a control system electrically communicating with the prime mover system; the control system comprising:
an unlocking base station comprising a wireless communication module capable of being paired with a hand-carried transmitter, wherein after the wireless communication module is successfully paired with the hand-carried transmitter, the unlocking base station is capable of receiving signals from the hand-carried transmitter by the wireless communication module; and
a control module electrically connected to the unlocking base station;
wherein the control module will start the prime mover system only after assessment of a distance between the unlocking base station and the hand-carried transmitter based on a signal received from the hand-carried transmitter, and wherein the control module will start the prime mover system only after authenticating the hand-carried transmitter based on authentication information in the signal received from the hand-carried transmitter.

20. The off-road vehicle of claim 19, wherein the prime mover system of the off-road vehicle can be started solely by user manipulation of the hand-carried transmitter, wherein the control module can place the off-road vehicle into a welcome state after assessing distance between the unlocking base station and the hand-carried transmitter to be less than a first distance threshold, wherein the hand-carried transmitter can only start the prime mover system of the off-road vehicle after assessing distance between the unlocking base station and the hand-carried transmitter to be less than a second distance threshold, with the first distance threshold being longer than the second distance threshold.
